(19) United States
(12) Patent Application Publication
(10) Pub. No.: US 2015/0298949 A1
(43) Pub. Date: Oct. 22, 2015

(54) Scissors Lift Platform

(71) Applicant: Christoph Mohr, Bielefeld (DE)

(72) Inventor: Christoph Mohr, Bielefeld (DE)

(21) Appl. No.: 14/424,179

(22) PCT Filed: Aug. 14, 2013
(86) PCT No.: PCT/EP2013/002461

§ 371 Date: Feb. 26, 2015

(30) Foreign Application Priority Data
Sep. 1, 2012 (DE) 20 2012 008 386.4

(51) Int. Cl. B66F 7/06

(52) U.S. Cl. CPC B66F 7/065

(57) ABSTRACT

A scissor-lift platform comprises a scissor mechanism (1) and scissor elements (3) that are connected to form scissor element pairs by central bearings (2). At least one scissor element (3) of a scissor element pair has a bearing receiving element (4) that is removably connected to the scissor element (3) in order to receive the central bearing (2).

### TECHNICAL FIELD

The invention relates to a scissor-lift platform and more particularly, to a scissor lift platform wherein a scissor mechanism and scissor elements are connected to form scissor element pairs by central bearings. At least one scissor element of a scissor element pair has a bearing receiving element that is removably connected to the scissor element in order to receive the central bearing.

### BACKGROUND INFORMATION

Scissor-lift platforms are already known. As a rule, the scissor mechanisms of such scissor-lift platforms are formed of two scissor blade pairs, which are spaced apart and connected to each other through suitable cross-bracings. The individual scissor blade pairs each have two scissor blades that are connected to each other through a central bearing and can rotate against each other. The central bearing is located at approximately half of the length of the scissor blades.

According to the prior art, pivoting bearings and self-lubricating slide bearings in particular, and so-called DU bushings in particular, have proven themselves for the central bearing.

According to the prior art, bore holes are introduced into the scissor blades and are designed such that they form a suitable bearing seat for the bearing to be used.

Not only with respect to its size but also with respect to its implementation, e.g., the surface condition, must the bore holes be designed such that they are suitable as a bearing seat for the bearing to be used. Since such scissor-lift platforms are typically one-offs, specified to a customer's desire, this means high production costs. Furthermore, subsequent replacement of the bearings, for example for repair or maintenance work, is difficult, if, for example, outer rings of the bearing are pressed into the bearing seats. In case of damage to a bearing, the scissor mechanism is most often also damaged to such an extent that significant repair effort or even replacement of the entire inner scissor mechanism becomes necessary. A change to a different bearing type or a different bearing size cannot be realized in a simple manner as well.

### SUMMARY OF THE INVENTION

The problem addressed by the invention is, therefore, to create a scissor-lift platform, where production, assembly and disassembly of the scissor blade pairs and their central bearing is possible in a simple and cost-effective manner.

According to the invention, the problem is solved in that at least one scissor blade of a scissor blade pair has a bearing receiving element detachably connected to the scissor blade for receiving a central bearing.

The bearing receiving element, which is preferably housed in a fitting opening—designed, for example, as a bore hole,—of the scissor blade, can be assembled and disassembled easily due to its detachable connection with the scissor blade. The advantage of such bearing receiving elements that are detachably connected with the scissor blade is that no bearing seat needs to be produced in the scissor blade during the manufacture of the scissor blades but only a connectivity of the scissor blade with the bearing receiving element needs to be provided. If an opening that receives the bearing receiving element inside the scissor blade is to be produced for this purpose, then the bearing can be provided inside the scissor blade, i.e., in the same position where it would also be located at a conventional scissor blade, i.e., no additional installation space is required in the width of the scissor blade pair.

According to the invention, the bearing receiving element has two essential features. For one, it is designed such that it can be connected detachably with the scissor blade, for which it preferably has a connection region, for example a flange. Furthermore, its outer contour must be designed such that it can be connected with the scissor blade.

The bearing receiving element is designed such that it is suitable for receiving the intended bearing, i.e., it has a receiving region, for example a bore hole for a bearing to be used, where said receiving region is designed such that it constitutes a suitable bearing seat for the used bearing type.

In the case of a pivoting bearing, this can also be a receptacle for a bolt, which is preferably housed in a manner preventing rotation and is supported rotatably in the pivoting bearing of the other scissor blade of the scissor blade pair. The advantage realized by this is that while the large-scale scissor blades only need to be provided with an interface suitable for the bearing receiving elements, which are preferably designed the same for all types of bearing receiving elements, the bearing seats, which are potentially subject to high tolerance requirements, are produced in relatively small, easily handled parts. Because the bearings are only inserted into the bearing receiving elements, for example pressed together, the bearing receiving element can now advantageously be replaced together with the bearing, which as a rule can take place in a simple manner directly on site and in the most favorable case even without removing the scissor blades from the scissor-lift platform due to the detachable connection.

Thus, according to the invention a modular system can be provided for the installation or replacement of central bearings in the scissor-lift platform. The concept of the modular system is based on the fact that the scissor blades have means of connection, in particular openings in their regions that are to be connected to each other through central bearings. Additionally, a plurality of various types of bearing receiving elements is available and can be connected selectively with the scissor blades. The various types of bearing receiving elements have differing inner contours each fitting for the respective central bearing that is to be housed in the bearing. This modular system according to the invention allows for combining different central bearing and scissor blade combinations in a simple manner.

Central bearings can also be exchanged with each other in a simple manner, for example if the design of the central bearing proves to be erroneous later on, if a bearing is worn and a bearing of the same design is no longer available. In any case, the replacement of a bearing with an identical bearing on site is also significantly simplified compared to conventional bearings.

### BRIEF DESCRIPTION OF THE FIGURES OF THE DRAWING

These and other features and advantages of the present invention will be better understood by reading the following detailed description, taken together with the drawings wherein:

FIG. 1 is a schematic presentation of an exemplary scissor-lift platform according to the invention;

FIG. 2 is a schematic exemplary presentation of a scissor-mechanism of an exemplary lift platform according to the invention;

FIG. 3 is an exploded schematic view of the connection of two scissor blades through the central bearing for an exemplary scissor-lift platform according to the invention; and

FIG. 4 is a similar exploded schematic view as in FIG. 3 using a different central bearing type.

### PREFERRED EMBODIMENT

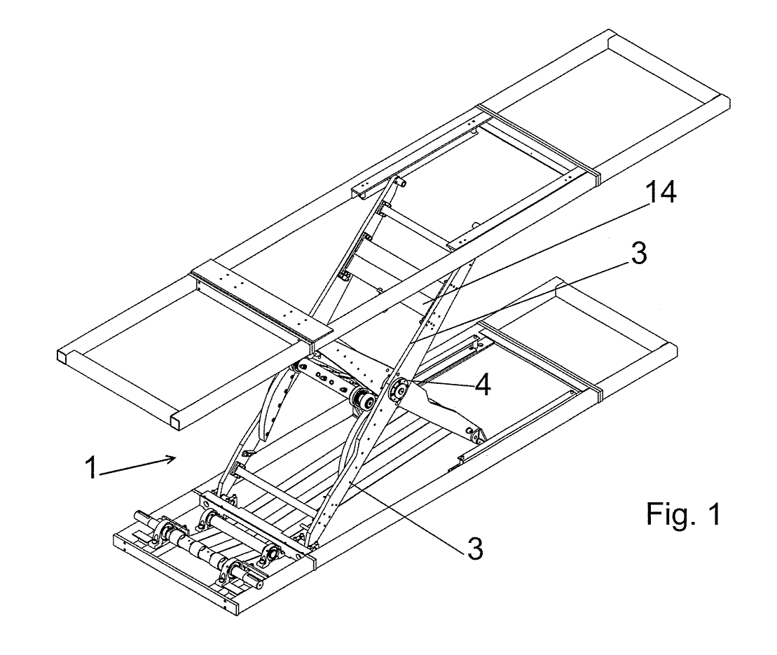

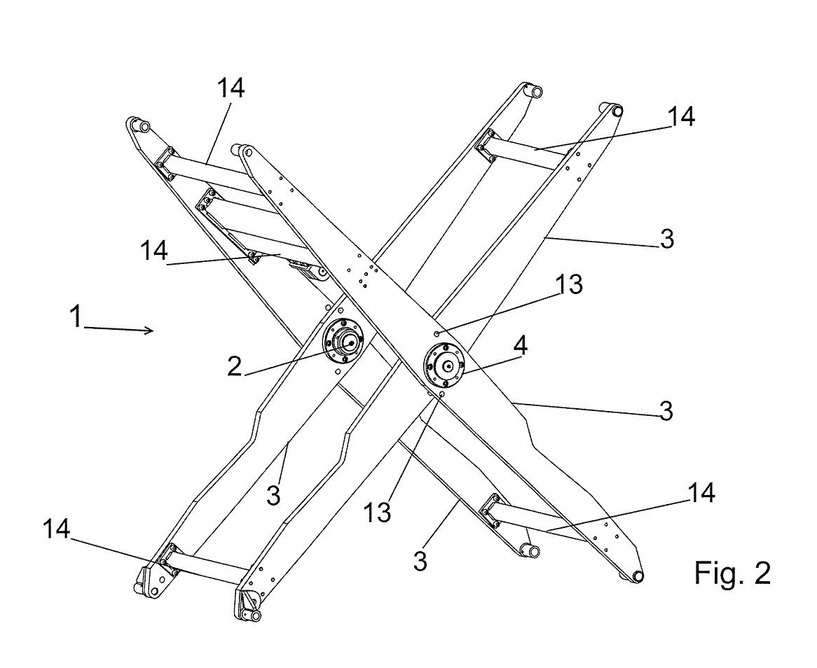

In the exemplary scissor-lift platform according to the invention, two scissor blades 3, FIGS. 1 and 2, each are connected into scissor blade pairs using a central bearing 2, which is housed in a bearing receiving element 4. The two scissor blade pairs are connected by cross bracing elements 14 to form a scissor blade mechanism 1.

The scissor blades 3 have means of connection in the form of openings 5 that are compatible with the bearing receiving elements 4, with the bearing receiving elements 4 being inserted in said opening 5. A connection region 6 of the bearing receiving elements 4, designed in the shown example as a flange, serves for detachable, rotation-preventive fastening of the bearing receiving elements 4 in the bearing blades 3.

In order to further simplify the replacement of the bearing receiving elements, the exemplary scissor-lift platforms may also have load-relieving device 13 that serves the purpose of securing the scissor mechanism such that the central bearing becomes load-free and thus can be removed from the scissor-lift platform in the ideal case without additional measures for disassembly of the entire scissor blade mechanism 1.

In the simplest embodiment, these load-relieving devices 13 can be designed in the form of bore holes located in the scissor blades 3 and are designed such that they overlap in the position of the scissor-lift platform desired for disassembly that a securing element, for example a socket pin, can be inserted and assume the loads that are otherwise assumed by the central bearing.

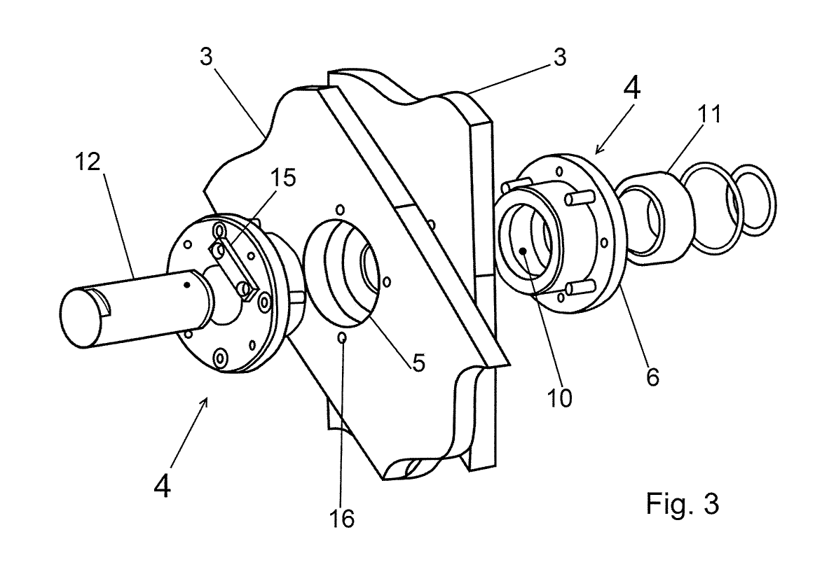

In the exemplary embodiment according to FIG. 3, a pivoting bearing 11 is used as the bearing. Accordingly, one of the bearing receiving elements 4 is provided with a bearing seat 10 for the outer ring of the pivoting bearing 11.

The bearing receiving element 4 in the other bearing blade 3 of the bearing blade pair has an opening for a bolt 12 with a protection against rotation 15. In the shown example, the bolt 12 is the shaft of the pivoting bearing 11 and accordingly is designed as a suitable bearing seat, in the shown example with a retainer ring.

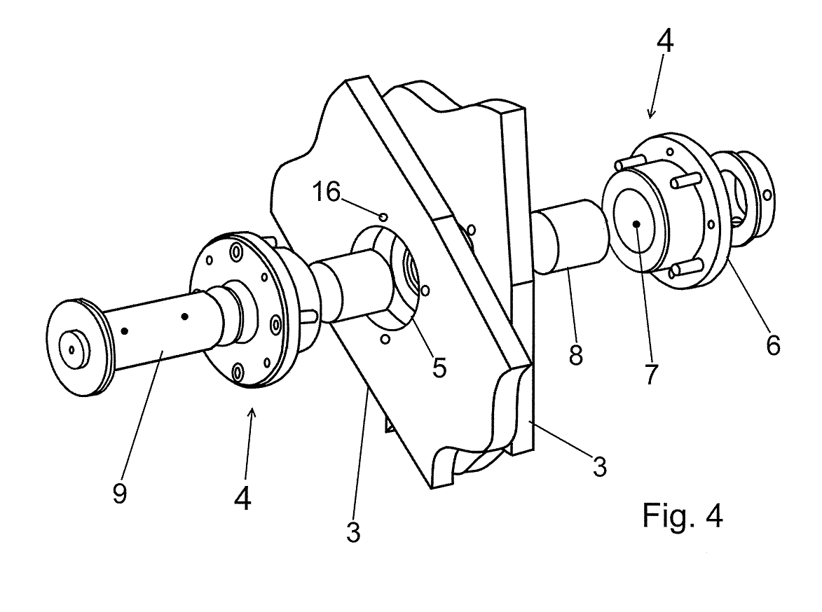

FIG. 4 shows an additional exemplary embodiment, where both scissor blades 3 of the shown scissor blade pair are connected with bearing receiving elements 4. In the shown example, both bearing receiving elements 4 receive bearing bushings 8 with a joint shaft 9. Each of the two bearing bushings 8 forms a slide bearing together with the shaft 9. In an advantageous manner, this bearing can be designed as a self-lubricating bearing, for example a DU bearing.

In the shown examples, screws are used for the detachable connection of the bearing receiving elements 4 with the scissor blades 3 as detachable fastening elements, and are screwed through the connection regions of the bearing receiving elements 4 designed as flanges 6 into bore holes 16 of the scissor blades 3 provided for this purpose.

Accordingly, the present invention provided a novel and non-obvious scissor lift mechanism wherein a scissor-lift platform comprises a scissor mechanism and scissor elements that are connected to form scissor element pairs by central bearings. At least one scissor element of a scissor element pair has a bearing receiving element that is removably connected to the scissor element in order to receive the central bearing.

Modifications and substitutions by one of ordinary skill in the art are considered to be within the scope of the present invention, which is not to be limited except by the allowed claims and their legal equivalents.

1. A scissor mechanism (1) for a scissor-lift platform, said scissor mechanism (1) comprising a plurality of scissor blades (3) connected through central bearings (2) to form first and second scissor blade pairs, characterized in that the at least one scissor blade (3) of each of the first and second scissor blade pairs includes a bearing receiving element (4) configured for housing a the central bearing (2), and wherein the bearing receiving element (4) is connected to the scissor blade (3) in a detachable manner.

2. The scissor-lift mechanism as in claim 1, characterized in that the bearing receiving element (4) is housed in a fitting opening (5) in said scissor blade, and wherein said fitting opening (5) a bore hole in the scissor blade (3).

3. The scissor-lift mechanism as in claim 1, characterized in that the bearing receiving element (4) has a connection region (6) formed as a flange.

4. The scissor-lift mechanism as in claim 3,
characterized in that the connection region (6) of the bearing receiving element (4), is connected with the scissor blade (3) by means of detachable fastening elements.

5. The scissor-lift mechanism as in claim 1,
characterized in that the bearing receiving element (4) has a bearing seat (7) for a bearing bushing (8) of a slide bearing, in particular a DU bearing.

6. The scissor-lift mechanism in claim 5, characterized in that both scissor blades (3) of a scissor blade pair have bearing receiving elements (4), wherein inside each of the bearing receiving elements (4) is housed a bearing bushing (8) of a slide bearing, in particular a DU bearing, together with a joint shaft (9).

7. The scissor-lift mechanism as in claim 1, characterized in that the bearing receiving element (4) has a bearing seat (10) for an outer ring of a pivoting bearing.

8. The scissor-lift mechanism as in claim 7, characterized in that one scissor blade (3) of a scissor blade pair has a bearing receiving element (4) that is modified for receiving a bolt (12), preferably in a rotation-preventing manner.

9. The scissor-lift mechanism as in claim 1, characterized in that the scissor-lift platform has a load-relieving device (13) for the relief of a central scissor bearing (2).

10. The scissor-lift mechanism as in claim 9, characterized in that the load-relieving device (13) is configured as one or more openings, in particular bore holes for a blocking element wherein said blocking element is a socket pin.

11. The scissor-lift mechanism of claim 1, characterized in that the plurality of scissor blades (3) have means of connection (5), in particular openings, in their regions that are to be connected to each other through central bearings (4), wherein a plurality of various types of bearing receiving elements (4) is available and can be connected selectively with the scissor blades (3), wherein the various types of bearing receiving elements (4) have different inner contours (7, 10) that fit the respective central bearing that is to be received in the bearing receiving element (4), and configured for the installation and/or the replacement of central bearings in scissor-lift mechanisms used in scissor-left platforms.
